(19) United States
(12) Patent Application Publication
(10) Pub. No.: US 2008/0158745 A1
(43) Pub. Date: Jul. 3, 2008

(54) Data transmission circuit with ESD protection and LCD thereof

(76) Inventors: Shyh-Feng Chen, Hsin-Chu (TW); Tsung-Cheng Lin, Hsin-Chu (TW); Shih-Chyn Lin, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 11/754,970

(22) Filed: May 29, 2007

(30) Foreign Application Priority Data
Dec. 29, 2006 (TW) 095149869

(51) Int. Cl. H02H 9/04; H02H 9/02

(52) U.S. Cl. 361/56; 361/57

(57) ABSTRACT

Data transmission circuit with ESD protection comprises a first set of data lines and a second set of data lines; a first set of ESD protection components coupled to the first set of data lines; a second set of ESD protection components coupled to the second set of data lines; a first current path coupled to the first set of ESD protection components for dispensing the ESD current; and a second current path coupled to the second set of ESD protection components for dispensing the ESD current.

### BACKGROUND OF THE INVENTION

1. Field of the Invention

The present invention relates to a data transmission circuit with electrostatic discharge(ESD) protection, and more particularly, to a data transmission circuit with ESD protection in a liquid crystal display(LCD)

2. Description of the Prior Art

Please refer to FIG. 1. FIG. 1 is a diagram illustrating a conventional LCD 100. The LCD 100 comprises a data transmission circuit 110 and a pixel driving circuit 120. The pixel driving circuit 120 comprises scan lines G1 to Gm for transmitting pixel driving signals to pixels. The data transmission circuit 110 comprises data lines D0 to Dn, ESD protection components E0 to En, and a current path P1. In the data transmission circuit 110, the data lines D0 to Dn transmit frame data to the pixels; each of the ESD components E0 to En has one end coupled to a corresponding data line, and the other end coupled to the current path P1 for protecting the corresponding data line from damage by ESD events, and dispersing the ESD currents by lead the ESD currents to the current path P1.

Please refer to FIG. 2. FIG. 2 is a diagram illustrating data lines D0 and D1. The data transmission circuit 110 transmits data of different polarities compared to the common voltage Vcom. And the polarities of data on different data lines can be the same or different. For example, the data transmission circuit 110 transmits data of positive polarity compared to the common voltage Vcom on the odd data lines D0, D2, D4 . . . , and Dn×1. The data transmission circuit 110 transmits data of negative polarity compared to the common voltage Vcom on the even data lines D1, D3, D5 . . . , and Dn. As shown in FIG. 2, the data line D0 transmits data of positive voltages, and the data line D1 transmits data of negative voltages. Thus, assumed that the corresponding voltage of data has a range from 0 to 5 volts, the voltage difference between the data lines D0 and D1 can be up to 10 volts as the voltage difference V×1 shown in FIG. 2. However, the behavior of the data transmission circuit 110 can be different with the description above. The data transmission circuit 110 can be defined to work in other manner. For example, the data transmission circuit 110 transmits data of negative polarity compared to the common voltage Vcom on the even data lines D0, D2, D4 . . . , and Dn−1. The data transmission circuit 110 transmits data of positive polarity compared to the common voltage Vcom on the odd data lines D1, D3, D5 . . . , and Dn. Or, the data transmission circuit 110 transmits data of negative polarity compared to the common voltage Vcom on the even data lines D0, D2, D4 . . . , and Dn−1 in a first period, and transmits data of positive polarity compared to the common voltage Vcom on the even data lines D0, D2, D4 . . . , and Dn−1 in a second period. Therefore, the voltage of a data line can be positive in a period and negative in other period.

Please refer to FIG. 3. FIG. 3 is a diagram illustrating the data lines D0 and D1. When the data transmission circuit 110 transmits data, the voltages the data lines D0 and D1 are positive compared to the common voltage Vcom in one period, and are negative compared to the common voltage Vcom in another period. As shown in FIG. 3, the dotted line represents the voltage of the data line D0, and the solid line represents the voltage of the data line D1. It is assumed that the voltage corresponding to data ranges from 0 to 5 volts. Therefore, the voltage difference between the data lines D0 and D1 may be up to 10 volts, as the voltage difference V×2 shown in FIG. 3.

There are too many examples about the driving method of the data lines to describe. Thus, the present invention provides some examples in order to illustrate that the data lines are driven by voltages of different polarities so that the voltage difference between data lines possibly may be over a ceiling.

Please refer to FIG. 4. FIG. 4 is a diagram illustrating the current flowing from the data line D0 to the data line D1 when there is a voltage difference between the data lines D0 and D1. In fact, the ESD protection component is not ideal, and leaks current when a voltage is applied to the ESD protection component. The size of the leakage current rises as the voltage applied to the ESD protection component rises. Under the assumption that the voltage corresponding to data ranges from 0 to 5 volts, if all the data lines transmit data with voltages of the same polarity, the voltage difference between any of the two data lines is only up to 5 volts. But, if the data lines are driven by the method illustrated in FIG. 2 or FIG. 3, the voltage difference between any of the two data lines may be over 5 volts. Consequently, even no ESD event happens, the ESD component still leaks current from the data line D0 to the data line D1 through the ESD component E0 and the current path P1. In this way, the voltage levels of the data lines D0 and D1 are affected, causing wrong voltages to be transmitted to the pixels and wrong frames to be displayed (causing attenuated voltages to be transmitted to the pixels and affect display quality. The leak current also increases the undesired power consumption of driving circuit.)

### SUMMARY OF THE INVENTION

The present invention provides a data transmission circuit with ESD protection. The data transmission circuit comprises a first set of data lines for receiving and transmitting data of a first type; a second set of data line for receiving and transmitting data of a second type; a first set of ESD protection components, each ESD protection component of the first set of the ESD protection components coupled to a corresponding data line of the first set of data lines; a second set of ESD protection components, each ESD protection component of the second set of the ESD protection components coupled to a corresponding data line of the second set of data lines; a first current path coupled to each ESD protection component of the first set of the ESD protection components; and a second current path coupled to each ESD protection component of the second set of the ESD protection components.

The present invention provides a LCD having data transmission circuit with ESD protection. The LCD comprises a first glass substrate comprising a pixel driving circuit comprising a plurality of scan lines for transmitting a plurality of driving signals; a data transmission circuit comprising a first set of data lines for receiving and transmitting data of a first type; a second set of data line for receiving and transmitting data of a second type; a first set of ESD protection components, each ESD protection component of the first set of the ESD protection components coupled to a corresponding data line of the first set of data lines; a second set of ESD protection components, each ESD protection component of the second set of the ESD protection components coupled to a corresponding data line of the second set of data lines; a first current path coupled to each ESD protection component of the first set of the ESD protection components; and a second current path coupled to each ESD protection component of the second set of the ESD protection components; a plurality of first pixel areas wherein each first pixel area is coupled to the pixel driving circuit and a corresponding data line of the first set of the data lines for receiving a corresponding driving signals of the plurality of driving signals and a corresponding data of the data of the first type; and a plurality of second pixel areas wherein each second pixel area is coupled to the pixel driving circuit and a corresponding data line of the second set of the data lines for receiving a corresponding driving signals of the plurality of driving signals and a corresponding data of the data of the second type; and a second glass substrate; and a liquid crystal layer disposed between the first glass substrate and the second glass substrate.

### BRIEF DESCRIPTION OF THE DRAWINGS

FIG. 1 is a diagram illustrating a conventional LCD.

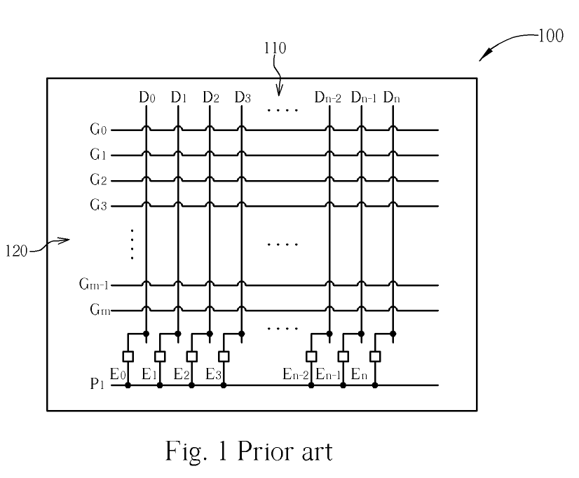

FIG. 2 is a diagram illustrating data lines.

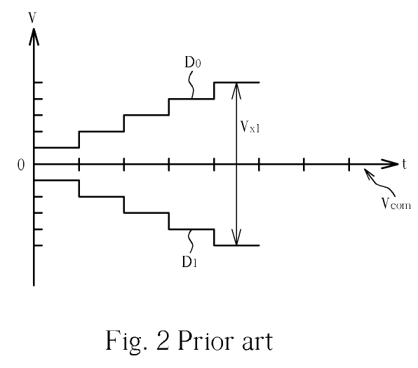

FIG. 3 is a diagram illustrating the data lines.

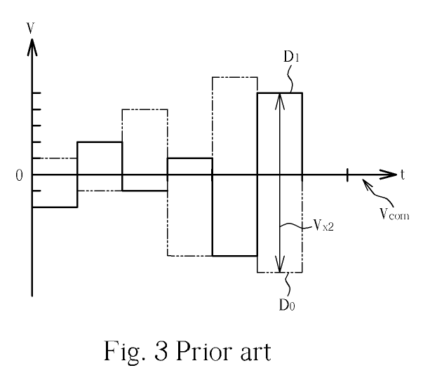

FIG. 4 is a diagram illustrating the current flowing from one data line to another data line when there is a voltage difference between the data lines.

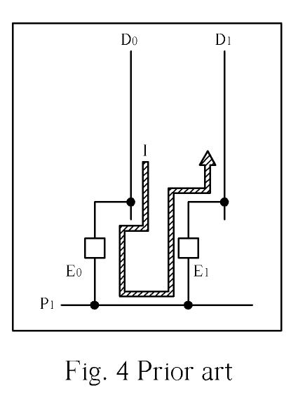

FIG. 5 is a diagram illustrating the data transmission circuit of the present invention.

FIG. 6 is a diagram illustrating a first embodiment of the ESD protection component En of the present invention.

FIG. 7 is a diagram illustrating the second embodiment of the ESD protection component En of the present invention.

FIG. 8 is a diagram illustrating a third embodiment of the ESD protection component En of the present invention.

FIG. 9 is a diagram illustrating a fourth embodiment of the ESD protection component En of the present invention.

FIG. 10 is a diagram illustrating a LCD of the present invention.

### DETAILED DESCRIPTION

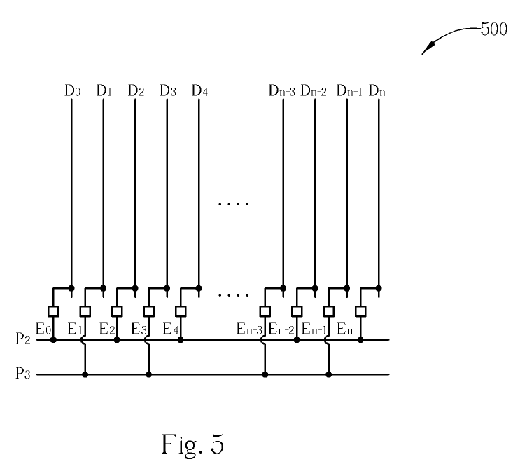

Please refer to FIG. 5. FIG. 5 is a diagram illustrating the data transmission circuit 500 of the present invention. As shown in FIG. 5, the data transmission circuit 500 comprises data lines D0, D1, D2, . . . , and Dn, ESD protection components E0, E1, E2, . . . , and En, and current paths P2 and P3. It is assumed that the voltages of the even data lines D0, D2, D4, . . . , and Dn−1 are positive, the voltages of the odd data lines D1, D3, D5, . . . , and Dn are negative, and the voltage range is also 5 volts. The present invention utilizes the character of the driving method of the data lines described above to design the transmission circuit 500: dividing the ESD components E0-En into two groups, coupling each group to the corresponding data lines and current paths. As shown in FIG. 5, one ends of the even ESD protection components E0, E2, E4, . . . , and En are respectively coupled to the corresponding data lines D0, D2, D4, . . . , and Dn, and the other ends of the even ESD protection components E0, E2, E4, . . . , and En−1 are conjointly coupled to the current path P2. One ends of the odd ESD protection components E1, E3, E5, . . . , and En are respectively coupled to the corresponding data lines D1, D3, D5, . . . , and Dn, and the other ends of the odd ESD protection components E1, E3, E5, . . . , and En are conjointly coupled to the current path P3. In this way, since the voltages of the even data lines D0, D2, D4, . . . , and Dn−1 are all positive and ranges in 5 volts, the voltage over each ESD components E0, E2, E4, . . . , and En−1 is not over 5 volts and no leakage current is generated if there is no ESD event. On the other hand, since the voltages of the odd data lines D1, D3, D5, . . . , and Dn are all negative and ranges in 5 volts, the voltage over each ESD components E1, E3, E5, . . . , and En is not over 5 volts and no leakage current is generated if there is no ESD event. Thus, the data transmission circuit 500 avoids current leakage caused by the voltage difference between two data lines over a ceiling.

However, it is only an example of the present invention to divide the ESD protection components into two groups in the data transmission circuit 500. The spirit of the present invention is to categorize the data lines by the voltages, and to couple the data lines of the same category to the same group of the ESD protection components and the current paths. In this way, the ESD protection components do not leak current caused by the voltage difference between the data lines of the same group. Thus, in reality, it is also possible to divide the ESD protection components and the current paths into more groups to prevent the ESD protection components from conducting when no ESD events happen.

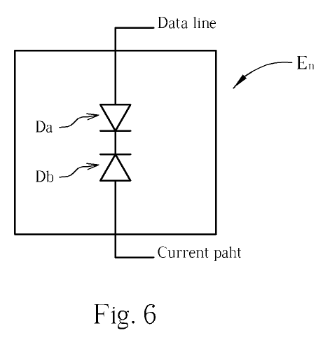

Please refer to FIG. 6. FIG. 6 is a diagram illustrating a first embodiment of the ESD protection component En of the present invention. As shown in FIG. 6, the ESD protection component En comprises two diodes Da and Db. The diode Da is reversely coupled to the diode Db.

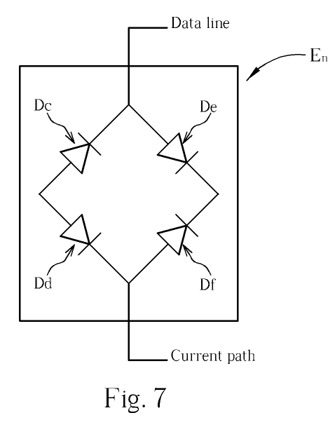

Please refer to FIG. 7. FIG. 7 is a diagram illustrating the second embodiment of the ESD protection component En of the present invention. As shown in FIG. 7, the ESD protection component En comprises 4 diodes Dc, Dd, De, and Df. A first back-to-back diode is composed of the diode Dc reversely coupled to the diode Dd. A second back-to-back diode is composed of the diode De reversely coupled to the diode Df. The first back-to-back diode is coupled to the second back-to-back diode in parallel.

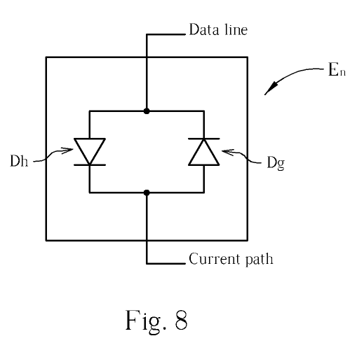

Please refer to FIG. 8. FIG. 8 is a diagram illustrating a third embodiment of the ESD protection component En of the present invention. As shown in FIG. 8, the ESD protection component En comprises two diodes Dg and Dh. The diode Dg is reversely coupled to the diode Dh in series.

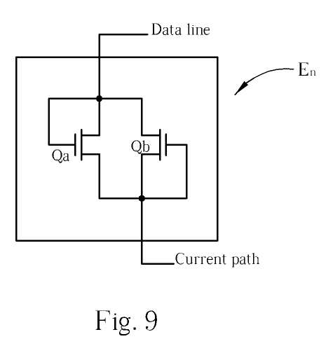

Please refer to FIG. 9. FIG. 9 is a diagram illustrating a fourth embodiment of the ESD protection component En of the present invention. As shown in FIG. 9, the ESD component En comprises two Metal Oxide Semiconductor(MOS) transistors Qa and Qb. The gate of the MOS transistor Qa is coupled to the data line, the first end of the MOS transistor Qa is coupled to the data line, and the second end of the MOS transistor Qa is coupled to the current path. The gate of the MOS transistor Qb is coupled to the current path, the first end of the MOS transistor Qb is coupled to the current path, and the second end of the MOS transistor Qb is coupled to the data line.

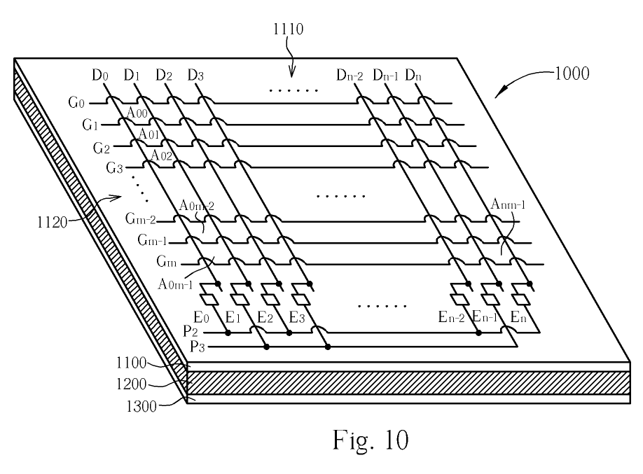

Please refer to FIG. 10. FIG. 10 is a diagram illustrating a LCD 1000 of the present invention. The LCD 1000 comprises a first glass substrate 1100, a liquid crystal layer 1200, and a second glass substrate 1300. The liquid crystal layer is disposed between the first and the second glass substrates 1100 and 1300. The first glass substrate 1100 comprises a data transmission circuit 1110 and the pixel driving circuit 1120. The data transmission circuit 1110 is composed as the same as the data transmission circuit 500 in FIG. 5. The pixel driving circuit 1120 is composed as the same as the pixel driving circuit 120. The data lines D0-Dn of the data transmission circuit 1110 interweave the scan lines of the pixel driving circuit 1120 and the plurality of the pixels A00, A01, A02, . . . , and Anm−1 are generated. The related description is the same as those described above and is omitted. Therefore, the LCD 1000 of the present invention avoids the ESD protection components conducting when no ESD events happen, which raises the display quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data transmission circuit with ESD protection comprising:
a first set of data lines for receiving and transmitting data of a first type;
a second set of data line for receiving and transmitting data of a second type;
a first set of electrostatic discharge (ESD) protection components, each ESD protection component of the first set of the ESD protection components coupled to a corresponding data line of the first set of data lines;
a second set of electrostatic discharge protection components, each ESD protection component of the second set of the ESD protection components coupled to a corresponding data line of the second set of data lines;
a first current path coupled to each ESD protection component of the first set of the ESD protection components; and
a second current path coupled to each ESD protection component of the second set of the ESD protection components.

2. The data transmission circuit of claim 1 wherein a voltage difference between a voltage corresponding to the data of the first type and a voltage corresponding to the data of the second type is able to exceed a voltage range of the data of the first type or a voltage range of the data of the second type.

3. The data transmission circuit of claim 1 wherein a ESD protection component of the first set of the ESD protection component comprises:
a first diode coupled between a corresponding data line of the first set of the data lines and the first current path; and
a second diode reversely coupled to the first diode in series.

4. The data transmission circuit of claim 1 wherein a ESD protection component of the first set of the ESD protection component comprises:
a first diode coupled between a corresponding data line of the first set of the data lines and the first current path; and
a second diode reversely coupled to the first diode in parallel.

5. The data transmission circuit of claim 1 wherein a ESD protection component of the first set of the ESD protection component comprises:
a first diode pair comprising:
a first diode coupled between a corresponding data line of the first set of the data lines and the first current path; and
a second diode coupled to the first diode in series; and
a second diode pair reversely coupled to the first diode pair, the second diode pair comprising:
a first diode; and
a second diode coupled to the first diode in series.

6. The data transmission circuit of claim 1 wherein a ESD protection component of the first set of the ESD protection component comprises:
a first metal oxide semiconductor(MOS) transistor comprising:
a gate coupled to a corresponding data line of the first set of the data lines;
a first end coupled to the corresponding data line of the first set of the data lines; and
a second end coupled to the first current path; and
a second MOS transistor comprising:
a gate coupled to the first current path;
a first end coupled to the corresponding data line of the first set of the data lines; and
a second end coupled to the first current path.

7. The data transmission circuit of claim 1 wherein a ESD protection component of the second set of the ESD protection component comprises:
a first diode coupled between a corresponding data line of the second set of the data lines and the second current path; and
a second diode reversely coupled to the first diode in series.

8. The data transmission circuit of claim 1 wherein a ESD protection component of the second set of the ESD protection component comprises:
a first diode coupled between a corresponding data line of the second set of the data lines and the second current path; and
a second diode reversely coupled to the first diode in parallel.

9. The data transmission circuit of claim 1 wherein a ESD protection component of the second set of the ESD protection component comprises:
a first diode pair comprising:
a first diode coupled between a corresponding data line of the second set of the data lines and the second current path; and
a second diode coupled to the first diode in series; and
a second diode pair reversely coupled to the first diode pair, the second diode pair comprising:
a first diode; and
a second diode coupled to the first diode in series.

10. The data transmission circuit of claim 1 wherein a ESD protection component of the second set of the ESD protection component comprises:
a first MOS transistor comprising:
a gate coupled to a corresponding data line of the second set of the data lines;
a first end coupled to the corresponding data line of the second set of the data lines; and
a second end coupled to the second current path; and
a second MOS transistor comprising:
a gate coupled to the second current path;
a first end coupled to the corresponding data line of the second set of the data lines; and
a second end coupled to the second current path.

11. A liquid crystal display (LCD) having data transmission circuit with ESD protection, the LCD comprising:
a plurality of scan lines; and
a data transmission circuit comprising:
a first set of data lines for receiving and transmitting data of a first type;
a second set of data line for receiving and transmitting data of a second type;
a first set of ESD protection components, each ESD protection component of the first set of the ESD protection components coupled to a corresponding data line of the first set of data lines;
a second set of electrostatic discharge protection components, each ESD protection component of the second set of the ESD protection components coupled to a corresponding data line of the second set of data lines;
a first current path coupled to each ESD protection component of the first set of the ESD protection components; and
a second current path coupled to each ESD protection component of the second set of the ESD protection components;
wherein the first set of data lines and the plurality of the scan lines define a plurality of first pixel areas and the second set of data lines and the plurality of the scan lines define a plurality of second pixel areas.

12. The LCD having data transmission circuit with ESD protection of claim 11 wherein a voltage difference between a voltage corresponding to the data of the first type and a voltage corresponding to the data of the second type is able to exceed a voltage range of the data of the first type or a voltage range of the data of the second type.

13. The LCD having data transmission circuit with ESD protection of claim 11 wherein a ESD protection component of the first set of the ESD protection component comprises:
a first diode coupled between a corresponding data line of the first set of the data lines and the first current path; and
a second diode reversely coupled to the first diode in series.

14. The LCD having data transmission circuit with ESD protection of claim 11 wherein a ESD protection component of the first set of the ESD protection component comprises:
a first diode coupled between a corresponding data line of the first set of the data lines and the first current path; and
a second diode reversely coupled to the first diode in parallel.

15. The LCD having data transmission circuit with ESD protection of claim 11 wherein a ESD protection component of the first set of the ESD protection component comprises:
a first diode pair comprising:
a first diode coupled between a corresponding data line of the first set of the data lines and the first current path; and
a second diode coupled to the first diode in series; and
a second diode pair reversely coupled to the first diode pair, the second diode pair comprising:
a first diode; and
a second diode coupled to the first diode in series.

16. The LCD having data transmission circuit with ESD protection of claim 11 wherein a ESD protection component of the first set of the ESD protection component comprises:
a first metal oxide semiconductor(MOS) transistor comprising:
a gate coupled to a corresponding data line of the first set of the data lines;
a first end coupled to the corresponding data line of the first set of the data lines; and
a second end coupled to the first current path; and
a second MOS transistor comprising:
a gate coupled to the first current path;
a first end coupled to the corresponding data line of the first set of the data lines; and
a second end coupled to the first current path.

17. The LCD having data transmission circuit with ESD protection of claim 11 wherein a ESD protection component of the second set of the ESD protection component comprises:
a first diode coupled between a corresponding data line of the second set of the data lines and the second current path; and
a second diode reversely coupled to the first diode in series.

18. The LCD having data transmission circuit with ESD protection of claim 11 wherein a ESD protection component of the second set of the ESD protection component comprises:
a first diode coupled between a corresponding data line of the second set of the data lines and the second current path; and
a second diode reversely coupled to the first diode in parallel.

19. The LCD having data transmission circuit with ESD protection of claim 11 wherein a ESD protection component of the second set of the ESD protection component comprises:
a first diode pair comprising:
a first diode coupled between a corresponding data line of the second set of the data lines and the second current path; and
a second diode coupled to the first diode in series; and
a second diode pair reversely coupled to the first diode pair, the second diode pair comprising:
a first diode; and
a second diode coupled to the first diode in series.

20. The LCD having data transmission circuit with ESD protection of claim 11 wherein a ESD protection component of the second set of the ESD protection component comprises:
a first metal oxide semiconductor(MOS) transistor comprising:
a gate coupled to a corresponding data line of the second set of the data lines;
a first end coupled to the corresponding data line of the second set of the data lines; and
a second end coupled to the second current path; and
a second MOS transistor comprising:
a gate coupled to the second current path;
a first end coupled to the corresponding data line of the second set of the data lines; and
a second end coupled to the second current path.
